(19) United States
(12) Patent Application Publication
(10) Pub. No.: US 2024/0067508 A1
(43) Pub. Date: Feb. 29, 2024

(54) Winch with Supporting Member

(71) Applicant: Hall Labs LLC, Provo, UT (US)

(72) Inventors: David R. Hall, Provo, UT (US); Jerome Miles, Spanish Fork, UT (US); Quinn Riley, Provo, UT (US)

(73) Assignee: Hall Labs LLC, Provo, UT (US)

(21) Appl. No.: 18/454,760

(22) Filed: Aug. 23, 2023

Related U.S. Application Data
(60) Provisional application No. 63/373,327, filed on Aug. 23, 2022.

(51) Int. Cl. B66D 1/36; B66D 1/30

(52) U.S. Cl. CPC B66D 1/36; B66D 1/30

(57) ABSTRACT

Disclosed is a winch. The winch includes a motor. A driveshaft that is coupled to the motor, and the motor rotates the driveshaft. End plates at opposite ends of the driveshaft are configured to support the driveshaft between the end plates, and to allow rotation of the driveshaft. A spool is fixed to the driveshaft such that the motor rotates the spool by rotating the driveshaft. A line is attached to the spool and rotation of the driveshaft causes the spool to wind the line onto the spool or unwind the line from the spool. At least one support member is coupled between the end plates. The at least one support member is generally parallel with and spaced apart from the rail, and the support member is fixed to the end plates such that the support member keeps the end plates and drive shaft in alignment.

### CROSS-REFERENCE TO RELATED APPLICATIONS

This application is a continuation-in-part of U.S. Provisional Patent Application No. 63/373,327, filed Aug. 23, 2022 and entitled, “Winch with Supporting Rod,” the entire disclosure of which is incorporated herein by reference.

### TECHNICAL FIELD

The present disclosure is directed to the field of lifters, hoists, and winches.

### BACKGROUND

Lifters, hoists, and winches are used extensively to lift, lower, or pull loads of various kinds. Such devices typically include a line, such as a cable or chain, wrapped around a spool. To lift, lower, or pull a load, the spool may be manually rotated or driven with a motor, such as an electrical, hydraulic, or pneumatic motor. When rotation is not desired, a braking mechanism may be used to prevent the spool from turning. This may maintain tension in the line, keep a load suspended, or prevent the release or unspooling of the line. To keep the line from bunching on the spool, some hoists or winches may include guides or other mechanisms to evenly wind the line around the spool.

Although a wide variety of lifters, hoists and winches are available, many have shortcomings that prevent or discourage their use in various applications. For example, some hoists or winches are bulky or cumbersome, which may prevent their use in applications where greater compactness is required or desired. Other hoists and winches may be economically infeasible for use in applications such as consumer or residential applications due to their complexity or expense.

Maintaining a flexible line in an orderly way and preventing excessive slack, bunching, and misalignment ensures proper winch operation. Without proper spacing, tension, and alignment the flexible line can become jammed or wear unevenly leading to material degradation or even failure. There is a need in the art for a winch that can maintain a flexible line in an efficient way to ensure a long effective life of the device.

### SUMMARY

Embodiments of the present disclosure are directed to a winch. The winch includes a motor. A driveshaft that is coupled to the motor, and the motor rotates the driveshaft. End plates at opposite ends of the driveshaft are configured to support the driveshaft between the end plates, and to allow rotation of the driveshaft. A spool is fixed to the driveshaft such that the motor rotates the spool by rotating the driveshaft. A line is attached to the spool and rotation of the driveshaft in a first direction causes the spool to wind the line onto the spool while rotation of the driveshaft in a second opposite direction causes the spool to unwind the line from the spool. A rail is coupled between the end plates. The rail is linked via gears to the driveshaft such that rotation of the driveshaft to unwind the line from the spool, rotates the rail in a direction opposite the driveshaft. A tensioning wheel is configured to contact the line. The tensioning wheel is rotated by the rail to thereby aid in unwinding the line from the spool. At least one support member is coupled between the end plates. The at least one support member is generally parallel with and spaced apart from the rail, and the support member is fixed to the end plates such that the support member keeps the end plates and drive shaft in alignment.

Further embodiments of the present disclosure are directed to a multi-spool winch. The multi-spool winch includes a driveshaft. A motor is coupled to the driveshaft and is configured to rotate the driveshaft in a first direction and a second direction opposite the first direction about a main axis of the driveshaft. A first spool is mounted to the driveshaft and carries a line that winds onto the first spool as the driveshaft rotates in a first direction and winds off of the first spool as the driveshaft rotates in a second direction. A first tensioning wheel is configured to contact the line. The first tensioning wheel rotated by the rail to thereby aid in winding the line onto the first spool and in winding the line off of first spool. A second spool is mounted to the driveshaft and carries a line that winds onto the second spool as the driveshaft rotates in a first direction and off of the second spool as the driveshaft rotates in a second direction. A second tensioning wheel configured to contact the line, the second tensioning wheel is rotated by the rail to thereby aid in winding the line onto the second spool assembly and in winding the line off of the second spool. End plates are positioned at either end of the driveshaft, the driveshaft being mounted to the endplates. A supporting member is fixedly coupled to the end plates parallel to and radially offset from the driveshaft and being configured to keep the end plates and driveshaft in alignment.

Still further embodiments of the present disclosure are directed to a winch. The winch includes a motor. A driveshaft is coupled to the motor and is driven by the motor to rotate a spool in a first direction and a second direction. The driveshaft winds a line onto a spool as the driveshaft as it is rotated in the first direction and off of the spool as the driveshaft rotates in the second direction. End plates are positioned at either end of the driveshaft and configured to allow the driveshaft to rotate. At least two support members are fixedly coupled to the end plates and being generally parallel with the driveshaft, the support members being configured to withstand twisting forces caused by the motor and the line.

Further aspects and embodiments are provided in the foregoing drawings, detailed description, and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is an isometric view of the winch with support members.

FIG. 2 is an internal isometric view of the winch with the support members removed to see the spools and driveshaft of the winch.

FIG. 3 is an alternative embodiment of the winch with two rods as support members.

FIG. 4a is a schematic of the winch with one support member.

FIG. 4b is a schematic of the winch with one rail that has twisted due to the rotational force of the motor.

FIG. 4c is a schematic of the winch with the rail bent.

FIG. 5 is a side view of a multiple spool driveshaft assembly for a winch according to embodiments of the present disclosure.

FIG. 6 is an enlarged view of a spool assembly according to embodiments of the present disclosure.

FIG. 7 is an end view of the driveshaft assembly according to embodiments of the present disclosure.

FIG. 8 is a schematic cross-sectional end view of a driveshaft and spool having a non-circular cross-sectional interface according to embodiments of the present disclosure.

FIG. 9 is a schematic cross-sectional end view of a driveshaft having depressions and spool having matching protrusions according to embodiments of the present disclosure.

FIG. 10 is an illustration of a winch assembly including two multiple spool driveshafts according to embodiments of the present disclosure.

FIG. 11 is an illustration of a multiple spool driveshaft assembly in which two spools are used for lifting lines and the other two spools deliver utilities according to embodiments of the present disclosure.

FIG. 12 illustrates a two-spool, single driveshaft assembly according to embodiments of the present disclosure.

FIG. 13 is a view of the winch attached to a ceiling.

FIG. 14 is a view of a portion of a mounting system.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, “winch” refers to lifting or pulling device consisting of a line winding around a horizontal rotating drum, turned by a crank or by motor or other power source.

As used herein, “winch,” “hoist,” “lift,” “winching device,” “hoisting device,” and “lifting device” are meant to refer to an apparatus that can be actuated to selectively raise and lower an object. These terms are generally interchangeable except for where specifically noted herein.

“Spool” is meant to refer to a generally cylindrical member that rotates to wind a line thereon.

“Line” is meant to refer to a cable, cord, wire, or other suitable interchangeable generally elongated, flexible, member that winds onto the spool.

As used herein, “supporting member” refers to structural elements of a winch assembly that provide support and rigidity to the winch assembly. Such elements include but are not limited to rods, struts, crossbars and other rigid components. Some supporting members are designed to include additional stiffening features that add to the rigidity and strength of the supporting member. The inclusion of supporting members ensures that the winch assembly is sufficiently rigid to withstand torsional or twisting forces caused by the rotation of the motor.

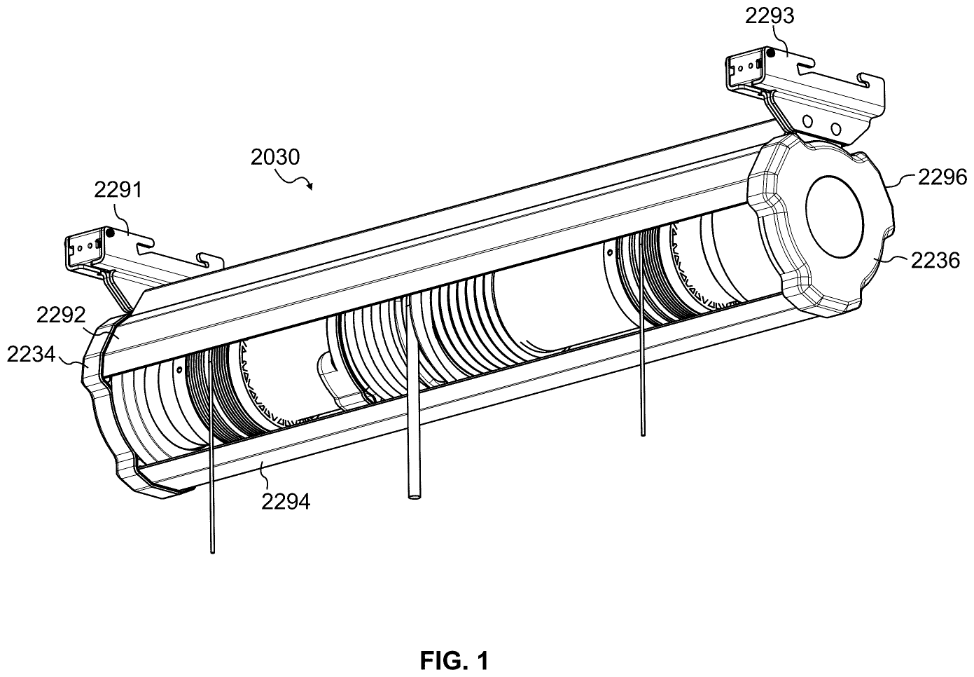

FIG. 1 depicts the winch assembly with support members in this embodiment the supporting members are crossbars 2292, 2294, and 2296. These crossbars are designed and manufactured to fit around a portion of the winch mechanism. These crossbars add stability and rigidity to the winch assembly. These crossbars fit around a portion of the driveshaft and spools of the winch mechanism. In some embodiments, each crossbar covers a sixth of the circumference of the driveshaft. In some embodiments, the amount of the driveshaft covered by each crossbar is about a twelfth of the circumference around the driveshaft. In some embodiments, the amount of the driveshaft covered by each crossbar is about a fourth of the circumference of the driveshaft. The shaping of the crossbars to fit around a portion of the driveshaft also adds rigidity to the crossbars, helping add to the rigidity of the winch mechanism. They are also shaped to fit within the endcaps. In some embodiments, such as that depicted in FIG. 1, the winch assembly includes three crossbars. The crossbars are connected to a first endplate 2234 and to a second end plate 2236 to create a system that is sufficiently rigid to withstand torsional or twisting forces placed on the rail as the winch assembly 2230 is operated. First crossbar 2292 connects to first endplate 2234 and spans the length of the winch assembly and connects to second endplate 2236. Second crossbar 2294 connects to first endplate 2234 and spans the length of the winch assembly and connects to second endplate 2236. Third crossbar 2296 connects to first endplate 2234 and spans the length of the winch assembly and connects to second endplate 2236. In some embodiments, the crossbars are connected to the endplates at a tie connector that is coupled to the end plates 2234. This can be accomplished by attaching each crossbar to the end plates 2234, by use of a screw or other means. Alternatively, each crossbar is formed integrally with the endplates 2234 and 2236. In yet other embodiments, a slot and tab assembly is used to attach each crossbar to the endplates. The crossbars are parallel with the rail and driveshaft. In some embodiments there is a single crossbar. In other embodiments, there are multiple crossbars. The winch assembly also includes mounting brackets 2291 and 2293 for attaching the winch assembly in place.

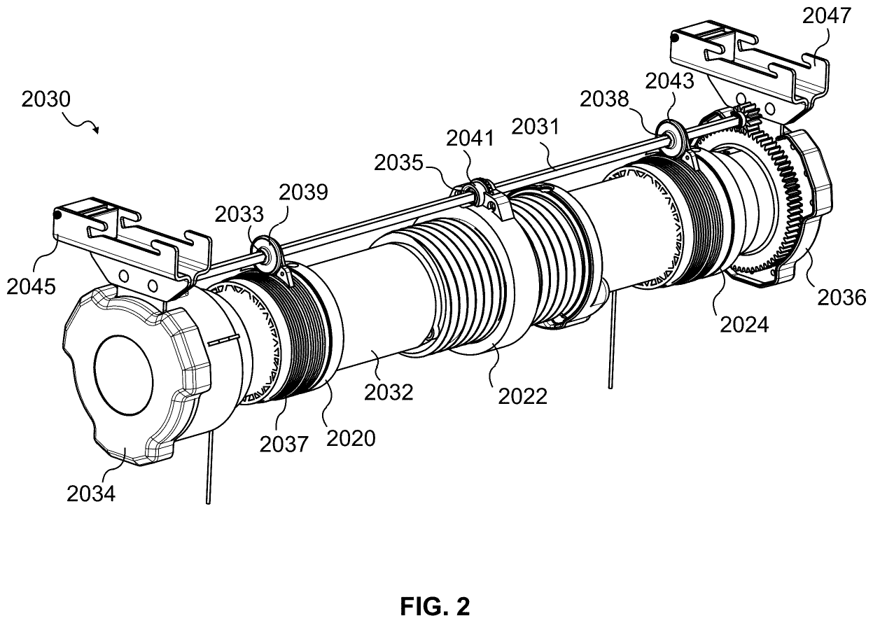

FIG. 2 is an isometric view of another embodiment of a winch assembly 2030. The winch assembly 2030 includes a driveshaft 2032, first end plate 2034 at one end and second endplate 2036 at an opposite end of the driveshaft, a rail 2031, and three spool assemblies: first spool assembly 2020, second spool assembly 2022, and third spool assembly 2024. There may be any suitable number of spool assemblies as desired for a given installation. In some embodiments each individual spool assembly is identical; however, in some embodiments each spool assembly carries a different type of line, such as a load-bearing line, a power/data cable, or even a fluid conduit such as an air tube or a water tube. As used here, the term “fluid” can refer to a vacuum.

The winch assembly 2030 includes a driveshaft 2032 that is an elongated cylindrical member. The length of the driveshaft 2032 can vary as needed according to various installations. A motor can be located within the driveshaft 2032 or can be externally mounted and provides the power to rotate the driveshaft 2032.

The spool assemblies are fitted to the driveshaft 2032 and can be selectively moved along the length of the driveshaft 2032. In some embodiments the spool assemblies are friction fit onto the spool assemblies such that they are movable by grasping and sliding them along the driveshaft 2032 but are otherwise maintain their position. In some embodiments there is a fastener such as a lever or set screw or any other suitable fastener that enables selective placement of the spool assemblies along the driveshaft 2032. In some embodiments the driveshaft 2032 is smooth, allowing for continuous placement of the spool assemblies at any desired position. In other embodiments the driveshaft 2032 has notches that receive a detent on the interior of the spool assemblies at desired spacings. In still other embodiments the driveshaft 2032 has a hexagonal shape to allow axial sliding of the spools but ensuring that the spools rotate with the driveshaft 2032. Other faceted shapes are also possible and is not limited to a hexagonal shape.

In the depicted embodiment, the spool assemblies attach to the rail 2031. In this embodiment a single rail is used to simplify the winch assembly. It is to be appreciated that this arrangement can vary as desired. There may be one, two, three, or more rails as needed, and any number of the spool assemblies can be attached to any of the rails.

The ability to move the spool assemblies along the driveshaft 2032 enables the lines to be positioned at different points along the driveshaft 2032 which can then be attached to an object to be lifted. By contrast, using two independent winches requires synchronization between the winches to achieve uniform raising and lowering of two or more lines. The winch assembly 2030 eliminates all synchronization issues because a single motor turns the spools at the same rate.

The first spool assembly 2020 includes a first component 2037 that is rotationally coupled to the driveshaft 2032. The first component 2037 includes grooves that carry the line as the line is wound onto and off of the first component 2037. The first spool assembly 2020 also includes a second component 2039 that is rotationally fixed to the end plates 2034. The second component 2039 includes a hole 2033 that receives the rail 2031 through the hole 2033 and facilitates rotation of the rail 2031. The second spool assembly 2022 also includes a second component 2041 that is rotationally fixed to the end plates 2034. The second component 2041 includes a hole 2035 that receives the rail 2031 through the hole 2033 and facilitates rotation of the rail 2031. The third spool assembly 2024 also includes a second component 2043 that is rotationally fixed to the end plates 2034. The second component 2043 includes a hole 2037 that receives the rail 2031 through the hole 2038 and facilitates rotation of the rail 2031. The winch assembly includes mounting brackets 2045 and 2047.

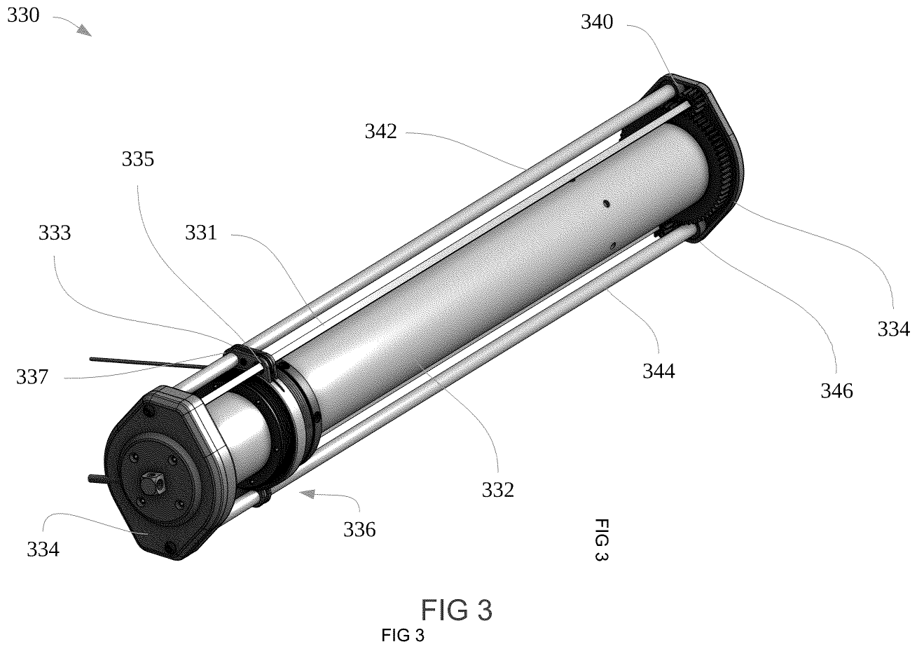

FIG. 3 is an isometric view of one embodiment of a winch assembly 330 including a supporting member, in this embodiment the supporting member is a rod 342. The winch assembly 330 includes a driveshaft 332, end plates 334 at opposite ends of the driveshaft, a rail 331, and a spool assembly 336. The spool assembly 336 includes a first component that is rotationally coupled to the driveshaft 332. The first component includes grooves that carry the line as the line is wound onto and off of the first component. The spool assembly 336 also includes a second component 337 that is rotationally fixed to the end plates 334. The second component 337 includes a hole 333 that receives the rod 342 through the hole 333. The rod 342 is stationary, as are the end plates 334 and the second component 339 of the spool assembly 336. The second component 337 also includes a rail hole 335 that receives the rail 331 and facilitates rotation of the rail 331. The winch assembly 330 can be generally similar to other winches shown and described herein. The rod can be incorporated equally into any other embodiment described herein.

The rod 342 is connected to each end plate at a tie rod connector 340 that is coupled to the end plates 334. This can be accomplished by attaching the rod 342 to the end plates 334, as depicted here, by use of a screw or other means. Alternatively, the rod 342 is formed integrally with the endplates 334. The rod 342 can be sufficiently rigid to withstand torsional forces placed on the rail 331 as the winch assembly 330 is operated. The rod 342 may be parallel with the rail 331. In some embodiments there are multiple rods. The winch assembly 330 can include a second rod 344 opposite the first rod 342. In other embodiments three or more rods can be used to provide sufficient stability to the winch assembly 330.

The second component 339 of the spool assembly 336 can include a hole 333 for the rod 342 and a rail hole 335 for the rail 331. The spool assembly 336 is permitted to slide along the driveshaft 332, the rail 331, and the rod 342 to allow the spool assembly 336 to move along the length of the driveshaft 332. The end plates 334 and the second component 337 thereby prevent twisting of the end plates 334 relative to one another which can cause problems.

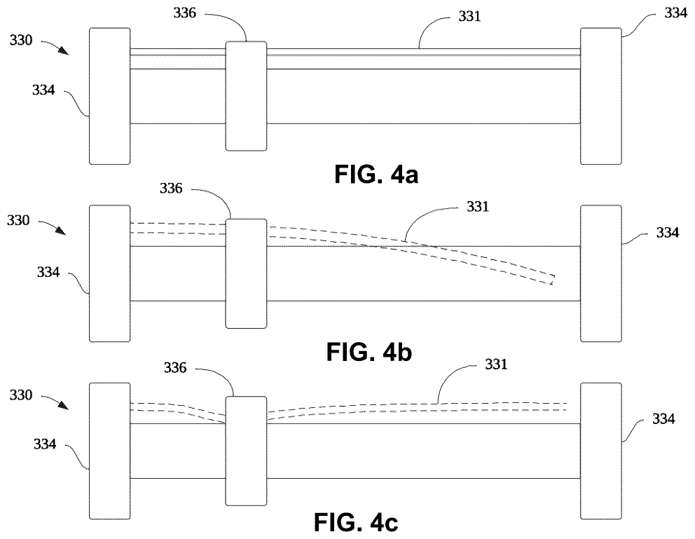

The winch assembly is designed to spool a line onto a spool assembly. FIG. 4a is a side view of the winch assembly as it is designed to function. The winch assembly 330 includes a driveshaft 332, end plates 334 at opposite ends of the driveshaft, a rail 331, and a spool assembly 336. Under ideal conditions, the spool assembly will rotate and spool a line onto the assembly. The rail will rotate to assist in the spooling on of the line. The rail will maintain contact with both endplates and will keep the spool assembly in proper alignment.

The winch assembly can run into certain problems that would hinder the ability of the winch assembly to function. FIGS. 4b and 4c depict two scenarios that can occur. In In FIG. 20b, the winch assembly 330 includes a driveshaft 332, end plates 334 at opposite ends of the driveshaft, a rail 331, and a spool assembly 336. In this scenario, the torsional or twisting force of the motor has caused the rail 331 to rotate with the driveshaft and has bent the rail 331 out of alignment with the driveshaft. In FIG. 20c the winch assembly 330 includes a driveshaft 332, end plates 334 at opposite ends of the driveshaft, a rail 331, and a spool assembly 336. The rail has shifted and become bent.

The issues illustrated by these scenarios are inhibited by the addition of supporting members such as rods or crossbars. While in some embodiments, one supporting member adds sufficient stability and rigidity to withstand the torsional and twisting forces applied to the winch, additional supporting members will provide further strength and rigidity to the winch to withstand the torsional or twisting forces

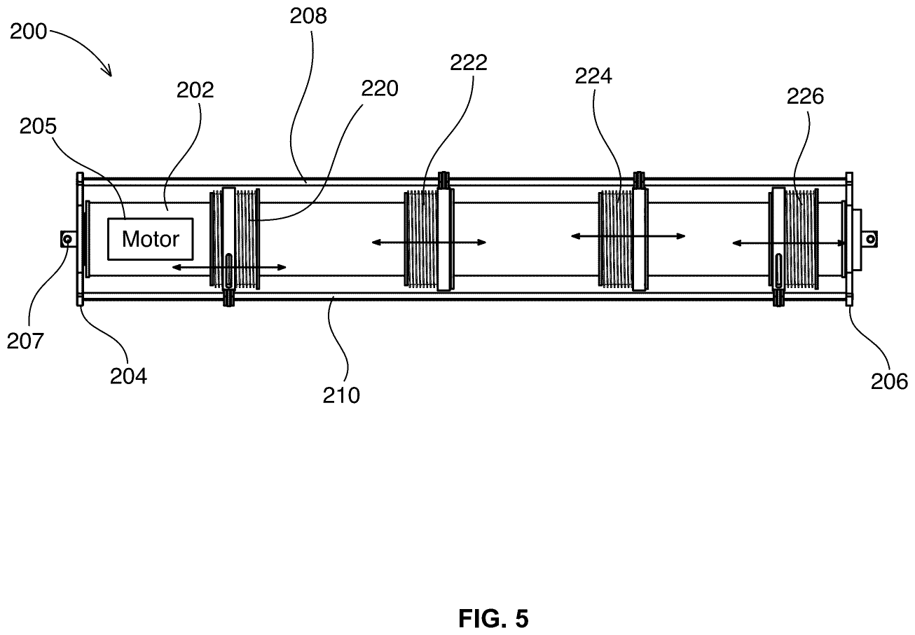

FIG. 5 is a side view of a multiple spool driveshaft assembly 200 for a winch according to embodiments of the present disclosure. The driveshaft assembly 200 can be used in a similar way to other winches that are used in garages or other such places to lift objects up and down as needed. The winches include a flexible line that winds onto and off of a spool to retract and extend the line from the winch. The line can be attached to any object to be lifted.

The driveshaft assembly 200 includes a driveshaft 202 that is an elongated cylindrical member. The length of the driveshaft 202 can vary as needed according to various installations. The assembly also includes a first end plate 204 and a second end plate 206 opposite the first end plate 204. A motor 205 can be located within the driveshaft 202 or can be externally mounted and provides the power to rotate the driveshaft 202. The driveshaft 202 can include a key 207 that can be used to mount the driveshaft 202 to the motor 205 in the case of an external mount. The assembly 200 also includes a first rail 208 and a second rail 210 rotatably connected to the end plates 204, 206, respectively. In some embodiments there may be a single rail.

The driveshaft assembly 200 also includes four spool assemblies: first spool assembly 220, second spool assembly 222, third spool assembly 224, and fourth spool assembly 226. There may be any suitable number of spool assemblies as desired for a given installation. In some embodiments each individual spool assembly is identical; however, in some embodiments each spool assembly can carry a different type of line, such as a load-bearing line, a power/data cable, or even a fluid conduit such as an air tube or a water tube. As used here, the term “fluid” can refer to a vacuum.

The spool assemblies are fitted to the driveshaft 202 and can be selectively moved along the length of the driveshaft 202. In some embodiments the spool assemblies are friction fit onto the spool assemblies such that they are movable by grasping and sliding them along the driveshaft 202 but are otherwise maintain their position. In some embodiments there is a fastener such as a lever or set screw or any other suitable fastener that enables selective placement of the spool assemblies along the driveshaft 202. In some embodiments the driveshaft 202 is smooth, allowing for continuous placement of the spool assemblies at any desired position. In other embodiments the driveshaft 202 can have notches that receive a detent on the interior of the spool assemblies at desired spacings. In still other embodiments the driveshaft 202 may have a hexagonal shape to allow axial sliding of the spools but ensuring that the spools rotate with the driveshaft 202. Other faceted shapes are also possible and is not limited to a hexagonal shape.

In the depicted embodiment, the first spool assembly 220 and fourth spool assembly 226 are attached to the second rail 210, and the second spool assembly 222 and third spool assembly 224 and fourth spool assembly 226 are attached to the first rail 208. It is to be appreciated that this arrangement can vary as desired. There may be one, two, three, or more rails as needed, and any number of the spool assemblies can be attached to any of the rails.

The ability to move the spool assemblies along the driveshaft 202 enables the lines to be positioned at different points along the driveshaft 202 which can then be attached to an object to be lifted. By contrast, using two independent winches requires synchronization between the winches to achieve uniform raising and lowering of two or more lines. The driveshaft assembly 200 eliminates all synchronization issues because a single motor turns the spools at the same rate.

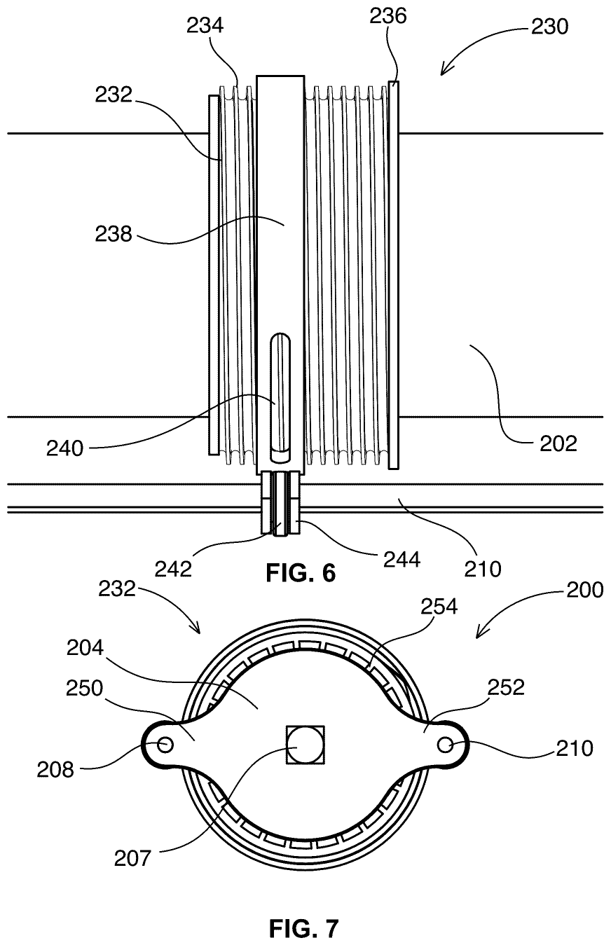

FIG. 6 is an enlarged view of a spool assembly 230 according to embodiments of the present disclosure. The spool assembly 230 includes a spool 232 having a helical groove 234 formed in an external surface of the spool 232. The helical groove 234 carries a line (not shown) wound around the spool 232. The spool 232 includes a flange 236 at one end of the spool 232 to provide an attachment point for the line. The spool assembly 230 also includes a line guide 238 that encircles the spool 232 and allows the line to wind onto the spool. The line guide 238 has a slot 240 through which the line passes.

The spool assembly 230 also includes a tensioning wheel 242 and a wheel support 244 to align the line as it winds onto and off of the spool 232. The wheel support 244 is mounted to the rail 210 with the tensioning wheel 242 being rotated by rotation of the rail 210, while the wheel support 244 allows the rail 210 to rotate within it. In some embodiments the wheel support 244 comprises a one-way bearing that can transfer torque in one direction and allows free movement in the other direction. The rotation of the rail 210 causes the one-way bearing to rotate the tensioning wheel 242 as the spool 232 rotates to pay out the line and to provide a slight tension to the line to ensure the line does not slack as it unwinds. When the spool 232 is rotated to wind the line, the one-way bearing does not transmit torque from the rail and the tensioning wheel 242 therefore does not inhibit the line winding around the spool 232. The rail 210 can rotate at a rate that causes the tensioning wheel 242 to slip slightly as the line is wound to the spool 232. The friction and slipping ensures that the line winds properly. In other words, the wheel speed is slightly faster than the line speed. The line guide 238, wheel support 244, and tensioning wheel 242 all move axially relative to the spool 232 as the spool 232 rotates. In some embodiments the line guide 238 is moved axially by the line, and in other embodiments the line guide 238 is keyed to the spool 232 such that the helical groove 234 causes the axial movement.

FIG. 7 is an end view of the driveshaft assembly 200 according to embodiments of the present disclosure. The key 207 for mating to an externally mounted motor is visible having a squared profile. A hexagonal or other torque-transmitting profile can also be found in some embodiments. The end plate 204 is shown and includes a first tab 250 for accommodating the first rail 208, and a second tab 252 for accommodating the second rail 210. The rails can rotate with respect to the tabs. In other embodiments there may be a single rail and accordingly the end plate 204 will have a single tab 250. In still other embodiments there may be three or more tabs accommodating three or more rails. The spool 232 is visible and includes spokes 254 that support the spool 232 and may provide sufficient flexibility to the spool 232 to allow selective movement along the driveshaft while grasping the driveshaft sufficiently firmly that rotation of the motor rotates the spool 232.

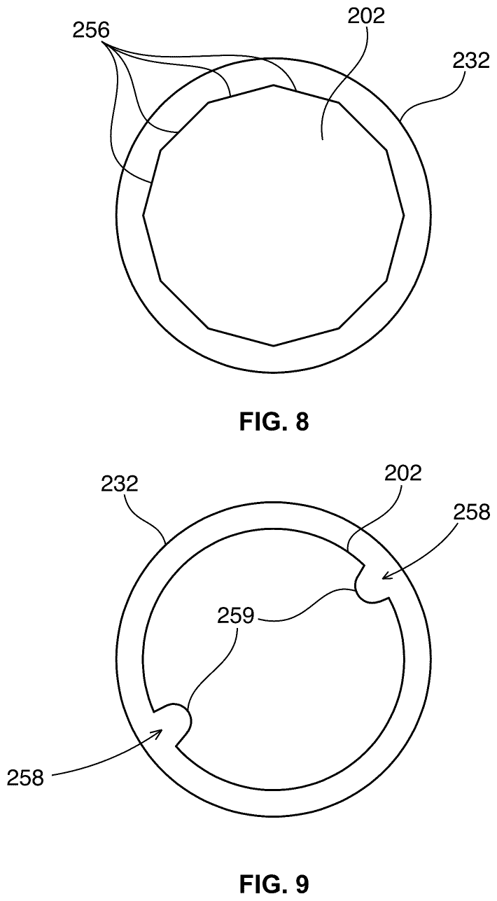

FIG. 8 is a schematic cross-sectional end view of a driveshaft 202 and spool 232 having a non-circular cross-sectional interface according to embodiments of the present disclosure. The driveshaft 202 has 12 flat sides 256 in the shown embodiment; however, any number of sides is possible within the scope of the present disclosure. The non-circular nature of the driveshaft 202 allows the spool (not pictured) to slide along the driveshaft but prevents rotation of the spool 232 around the driveshaft 202 thus allowing the driveshaft to drive the spool 232 without slipping.

FIG. 9 is a schematic cross-sectional end view of a driveshaft 202 having depressions 258 and spool 232 having matching protrusions 259 according to embodiments of the present disclosure. The depressions 258 can be rounded, squared, or any other suitable shape that will constrain the protrusions 259 in the spool 232 to match the depressions 258 such that the spool 232 and driveshaft 202 do not rotate relative to one another. The depressions 258 and protrusions 259 may be located at a specific axial position on the driveshaft 202 in which case the spool 232 has specific axial positions in which to operate. In other embodiments the depressions 258 extend axially along at least part of the length of the driveshaft 202 such that there may be more than one axial position for the spool 232 to engage. In some embodiments the depressions 258 extend the entire length of the driveshaft 202. The relative size of the depressions 258 and protrusions 259 may be larger or smaller than what is shown. The protrusions 259 may be spring-loaded such that the spool 232 can slide along the driveshaft 202 with the protrusions 259 recessed into the spool 232, and when the protrusions 259 reach a depression 258 the protrusion 259 extends into the depression 258. The depressions 258 may be rounded such that the depression/protrusion interface prevents relative rotation, but if sufficient torque is applied the protrusion 259 will recess and allow the spool 232 to rotate. In some embodiments the depressions 258 are rounded in the axial direction to permit the protrusions 259 to leave a depression 258 if moved axially relative to the driveshaft 202 but preventing relative rotation between the spool 232 and driveshaft 202. In some embodiments the protrusions 259 can be accessed from the outer surface of the spool 232 such that without a line wound on the spool the protrusions 259 can be actuated manually to release the spool 232 from the driveshaft 202.

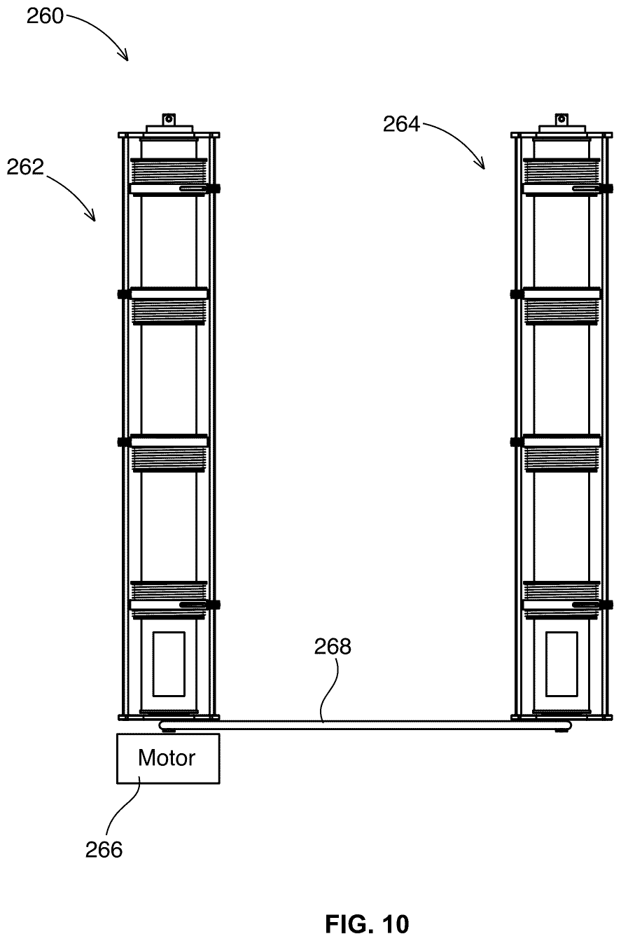

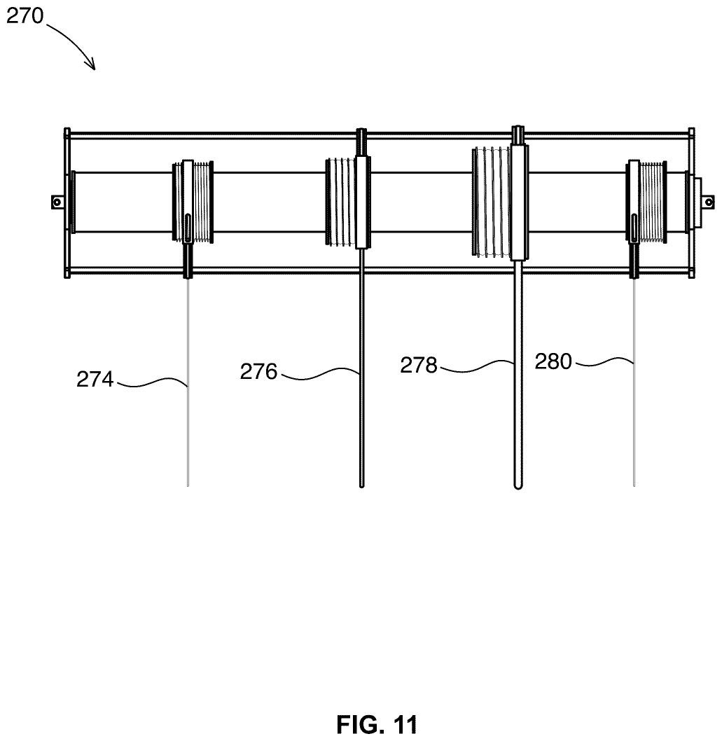

FIG. 10 is an illustration of a winch assembly 260 including two multiple spool driveshafts according to embodiments of the present disclosure. The winch assembly 260 includes a first multiple spool driveshaft assembly 262 and a second multiple spool driveshaft assembly 264. A motor 266 is coupled to the first multiple spool driveshaft assembly 262 directly and a coupler 268 connects the motor 266 to the second multiple spool driveshaft assembly 264. Accordingly, the motor 266 can operate both multiple spool driveshaft assemblies in unison. The coupler 268 can be a belt or a chain or any other suitable mechanical equivalent.

In other embodiments each multiple spool driveshaft assembly has its own motor, and the motors are synchronized together by a wireless connection, for example as taught in U.S. Pat. No. 9,624,076, entitled Synchronized Motorized Lifting Devices for Lifting Shared Loads. In still other embodiments three or more multiple spool driveshaft assemblies can be used.

The winch assembly 260 enables a plurality of lifting points, each from a separate spool. The spools can be placed in any available position resulting in many positioning possibilities. Using two or more multiple spool driveshafts allows for three points of contact which can provide more stability and a more secure vertical path for the object to be lifted. One such application of this winch assembly 260 is for an appliance such as a washing machine in a modular dwelling. Washing machines are relatively heavy and may be desired to remain in a precise vertical path. The winch assembly 260 can have one spool for each corner of the washing machine to ensure that it can be raised and lowered precisely without fear of jamming or wobble.

FIG. 11 is an illustration of a multiple spool driveshaft assembly 270 in which each spool carries a line of a different variety according to embodiments of the present disclosure. In this embodiment, at least one line is configured to lift and lower an object and least one other line is configured to deliver at least one utility selected from electric power, data, and fluid. In the depicted embodiment, the device has two load-bearing lines and two utility delivering lines. For example, the multiple spool driveshaft assembly 270 can carry an electrical line capable of transmitting electrical power and/or signals. Another possibility is a fluid line capable of conveying a fluid such as water, air, fuel, or any other fluid substance. In a deployment such as the washing machine for a modular dwelling discussed above for example, the washing machine may need to be physically raised and lowered, and provided with electricity for information and power, and the water supplied to the washing machine can also be provided via a line provided by one of the spool assemblies.

In the depicted embodiment a first line 274 and fourth line 280 may be load-bearing physical winch lines. The second line 276 may deliver electric power and the third line 278 may be deliver fluid such as water. The lines may one or more of several possible line types. The line types include fiber optic, electrical power, electrical data, USB, Ethernet, audio, HDMI, display port, PS/2, SATA, LIGHTNING™, or Firewire™. Fiber optic lines are categorized herein as electrical lines inasmuch as fiber optics are used inter alia to transmit data. The line types may also be for fluids, such as a gas or a liquid. The gas may be air, oxygen, hydrogen, nitrogen, helium, or any other conceivable gas. The liquid may be water, gasoline, hand sanitizer, or any other conceivable liquid material.

The non-load bearing lines, i.e., the lines delivering a utility, may be connected with a small amount of slack to be sure there is no unwanted tension on a line that is not designed to hold the weight. In some embodiments the various lines have different diameters, and the corresponding spools can accommodate the different diameters. The spools can have different helical groove sizes and pitches. The spool assemblies also have line guides such as that shown and described in detail with respect to FIGS. 7 and 8 that provide tension on the lines using tensioning wheels and wheel supports. To accommodate lines of different sizes, the rails and tensioning wheels can be configured to frictionally slip along the lines so there is tension as the lines are played out from the spools. The wheel supports for the spool assemblies can feature one-way bearings that tension the line when the line is paying out and allows the lines to pay out freely in the other direction.

To facilitate a line carrying a fluid, it is preferred to use a rotary union, i.e., a coupling of the line with a source of the fluid through means of a union that allows for rotation of the drive shaft and spool. Such a union provides a seal between the stationary supply, such as pipe or tubing and the rotating spool to enable the flow of a fluid into and/or out of the line.

To facilitate a line carrying electricity, either to power a device or to transmit analog or digital electric signals, it is preferred to equip the device with at least one slip ring, namely a coupling that provides a sliding electrical contact so that the stationary line can be in electrical communication with the rotating spool and thus the line carrying electricity. An induction coupling could also be used in certain embodiments.

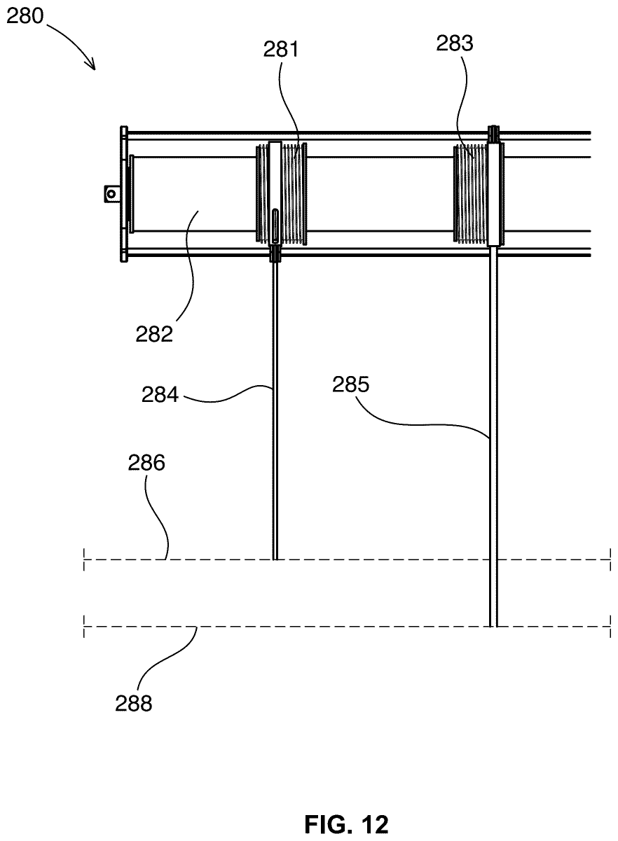

FIG. 12 illustrates a two-spool, single driveshaft assembly 280 according to embodiments of the present disclosure. A first spool 281 is at a first position on the driveshaft 282. A second spool 283 is at a second position on the driveshaft 282. The first spool 281 carries a first line 284 and the second spool 283 carries a second line 285. The lines may be the same line type or a different line type. The lines may have the same diameter, or the diameters may be different. The spools may have the same dimensions in terms of circumference and pitch of the helical groove, or they may be different.

The first line 284 has a first deployment distance 286 and the second line 285 has a second deployment distance 288. An example of a desired deployment distance may be a tool on a workbench. The first line 284 may carry an electrical power line that connects to the tool on the workbench. The second line 285 may carry an electrical power line for a different tool that sits on the ground next to the workbench. The driveshaft assembly 280, including spools 281, 283 and the various dimensions of the spools including diameter, helical groove shape, etc. is constructed such that both the first line 284 and the second line 285 reach their respective deployment distances once the driveshaft 282 has rotated a predetermined distance. The spools 281, 283 will complete the same number of revolutions, but the sizes of the spool and the pitch of the helical groove and the effective diameter of each respective line on the spool varies to achieve the same deployment distance. In some embodiments the deployment distance includes a certain amount of slack in the line once the line reaches the deployment distance. In some embodiments the deployment distance is the same, but the diameter of the lines is different, and the spool and helical groove dimensions are adjusted accordingly.

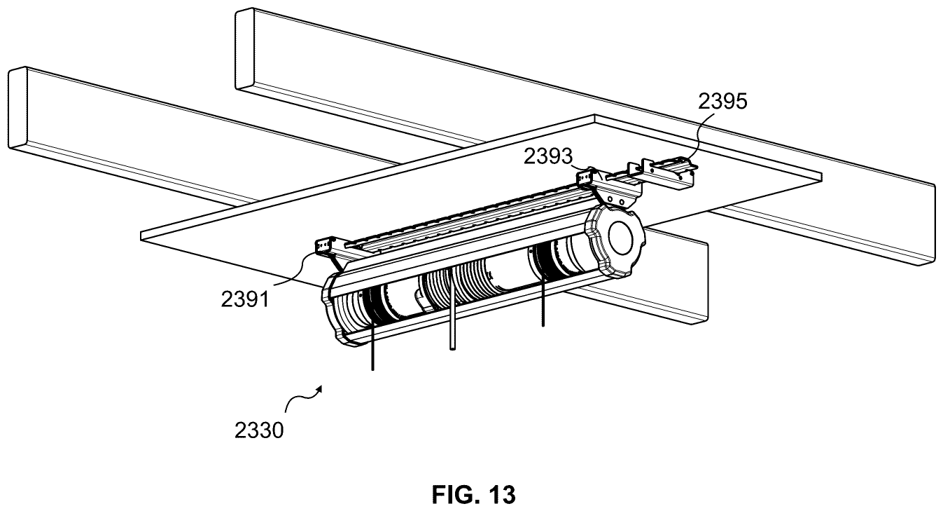

The winch assembly is to be used in many types of locations. Some winch assemblies will be placed on the ceiling of a garage. FIG. 13 shows the winch assembly 2330 attached to a ceiling. The winch assembly 2330 includes mounting brackets 2391 and 2393 that attach to mounting rail 2395. The mounting rail 2395 and brackets 2391 and 2393 are designed so the winch assembly can be attached at multiple positions along the rail. The brackets enable toolless attachment to the mounting rail and removal from the rail.

Some winch assemblies will be placed on the underside of a platform or shelf, and others will be placed in the cargo hold of a vehicle such as an aircraft or a semi-trailer. A mounting system that is secure yet enables easy installation and removal of the winch assembly is preferred.

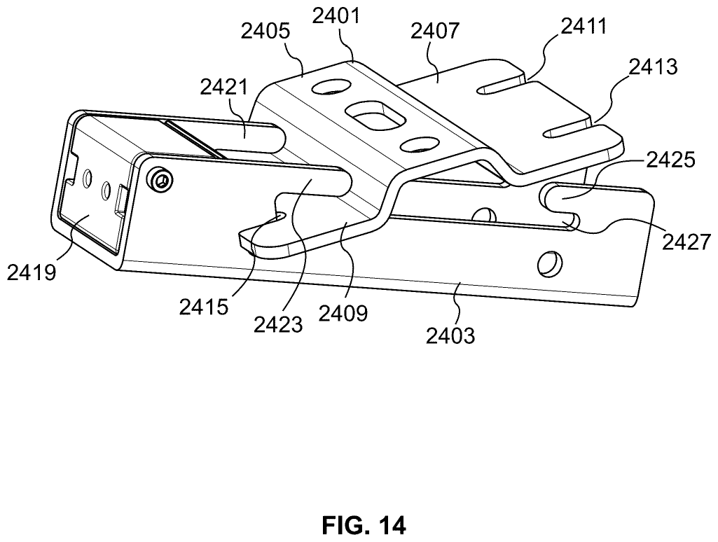

FIG. 14 is a view of a portion of the mounting rail and mounting bracket of the winch assembly. The mounting rail 2401 is designed so the mounting bracket 2403 has is able to be installed without tools. The mounting rail 2401 includes a central ridge 2405 which is raised from the side wings 2407 and 2409. The central ridge includes holes through which screws are positioned to secure the mounting rail to the ceiling or other surface to which the mounting rail is attached. The central ridge and side wings run the length of the mounting rail. Side wing 2407 includes cutouts 2411 and 2413, and side wing 2409 includes cutout 2415 and another cutout (which is not visible because of the positioning of the bracket). Bracket 2417 includes holding arms 2421, 2423, and 2425. Bracket 2417 also includes spring mechanism 2419. To install the winch assembly mounted on the brackets, the bracket is tilted and holding arms 2421 and 2423 are raised through the cutouts on side wing 2409. The cutouts on side wing 2409 are made to accommodate the bracket in the tilted position and so have a triangular shape permitting the positioning of the bracket. This can be seen in the mounting brackets of FIGS. 21 and 22. Once the holding arms 2421 and 2423 are lifted through the cutouts on side wing 2409, the bracket is pushed toward the central ridge 2405. Pushing the bracket toward the central ridge compresses the spring mechanism 2419. As the bracket is pushed towards the central ridge, holding arms 2425 and another holding arm (which is hidden by the bracket in this view) are raised through cutouts 2411 and 2413. Once the holding arms are raised through the cutouts 2411 and 2413, the spring pushes the bracket so the holding arms 2425 and 2427 overhang the side wing 2407, and side wing 2407 slides into bracket cutout 2427. The holding arms hold the bracket and what is attached to the bracket up. The cutouts prevent the bracket from moving laterally. The cutouts thus provide stability to the brackets to provide a stable mounting method for the winch assembly.

All patents and published patent applications referred to herein are incorporated herein by reference. The invention has been described with reference to various specific and preferred embodiments and techniques. Nevertheless, it is understood that many variations and modifications may be made while remaining within the spirit and scope of the invention.

What is claimed is:

1. A winch, comprising:
a motor;
a driveshaft coupled to the motor, wherein the motor rotates the driveshaft;
end plates at opposite ends of the driveshaft configured to support the driveshaft between the end plates, and to allow rotation of the driveshaft;
a spool fixed to the driveshaft such that the motor rotates the spool by rotating the driveshaft;
a line attached to the spool, wherein rotation of the driveshaft in a first direction causes the spool to wind the line onto the spool and wherein rotation of the driveshaft in a second opposite direction causes the spool unwind the line from the spool;
a rail extending between the end plates, the rail being linked via gears to the driveshaft such that rotation of the driveshaft to unwind the line from the spool, rotates the rail in a direction opposite the driveshaft;
a tensioning wheel configured to contact the line, the tensioning wheel rotated by the rail to thereby aid unwinding the line from the spool; and
at least one support member coupled between the end plates, generally parallel with and spaced apart from the rail, the support member fixed to the end plates such that the support member keeps the end plates and drive shaft in alignment.

2. The winch of claim 1, wherein the support member is a first rod.

3. The winch of claim 2, further comprising a second rod coupled between the end plates, spaced apart from and parallel to the first rod.

4. The winch of claim 2, wherein the tensioning wheel is held by a component that includes a hole configured to receive the rod passing through the hole.

5. The winch of claim 4, wherein the spool is configured to be positioned axially along the driveshaft.

6. The winch of claim 1 wherein the support member is a first crossbar.

7. The winch of claim 6, further comprising a second crossbar and a third crossbar wherein the crossbars are positioned radially around the driveshaft and apart from the driveshaft and each other.

8. A multi spool winch, comprising:
a driveshaft;
a motor coupled to the driveshaft and being configured to rotate the driveshaft in a first direction and in a second direction opposite the first direction about a main axis of the driveshaft;
end plates at either end of the driveshaft, the driveshaft being mounted to the endplates;
a first rail extending between the end plates parallel to and radially offset from the driveshaft, coupled via gears to the driveshaft such that rotation of the driveshaft to unwind a first line causes the rail to rotate in the opposite direction;
a first spool mounted to the driveshaft carrying the first line that winds onto the first spool as the driveshaft rotates in a first direction and unwinds the first line off of the first spool as the driveshaft rotates in a second direction;
a first tensioning wheel configured to contact the line, the first tensioning wheel rotated by the first rail to thereby aid in unwinding the first off of the first spool;
a second spool mounted to the driveshaft carrying a second line that winds onto the second spool as the driveshaft rotates in a first direction and off of the second spool as the driveshaft rotates in a second direction;
a second tensioning wheel configured to contact the line; and
at least one supporting member fixedly coupled to the end plates parallel to and radially offset from the driveshaft and being configured to keep the end plates and driveshaft in alignment.

9. The winch of claim 8, wherein the support member is a first rod.

10. The winch of claim 8, further comprising a second rod positioned radially offset from and parallel with the driveshaft.

11. The winch of claim 8, further comprising a second rail, the second rail rotates the second tensioning wheel to thereby aid in unwinding the second line off of the second spool.

12. The winch of claim 8, wherein the support member is a first crossbar.

13. The winch of claim 12, further comprising a second crossbar positioned radially offset from and parallel with the driveshaft.

14. The winch of claim 13, further comprising a third crossbar, wherein the three crossbars are positioned apart from one another.

15. A winch, comprising:
a motor;
a driveshaft coupled to the motor and being driven by the motor to rotate a spool in a first direction and a second opposite direction, wherein the driveshaft winds a line onto the spool as it is rotated in the first direction and off of the spool as it is rotated in the second opposite direction;
end plates at either end of the driveshaft configured to allow the driveshaft to rotate; and
at least two support members fixedly coupled to the end plates and being generally parallel with the driveshaft, the support members being configured to withstand twisting forces caused by the motor and the line.

16. The winch of claim 15, further comprising a tensioning wheel configured to contact the line, to thereby aid in unwinding the line from the driveshaft.

17. The winch of claim 15, wherein the at least two support members are crossbars, positioned apart from the driveshaft.

18. The winch of claim 17, further comprising a third crossbar positioned radially around the driveshaft, and apart from the first and second crossbars.

19. The winch of claim 15, further comprising a mounting system, the mounting system comprising:
a bracket with supporting arms and a spring; and
a mounting rail with side wings, the side wings having slots therein;
wherein during the installation process the supporting arms slide into slots in the side wings of the mounting rail and the spring holds the supporting arms in place while the bracket is installed.

20. The winch of claim 19, wherein the mounting brackets enable the winch to be attached to the mounting rail to position the winch at various points along the mounting rail.
